(19) United States
(12) Patent Application Publication
(10) Pub. No.: US 2010/0293832 A1
(43) Pub. Date: Nov. 25, 2010

(54) FISHING LURE

(76) Inventor: Terence P. Woodcock, Cornwall (GB)

Correspondence Address: ROETZEL & ANDRESS, 1375 EAST 9TH STREET, CLEVELAND, OH, 44114, US

(21) Appl. No.: 12/738,870

(22) PCT Filed: Oct. 20, 2008
(86) PCT No.: PCT/GB08/03554

§ 371 Date: Jul. 30, 2010

(30) Foreign Application Priority Data
Oct. 20, 2007 (GB) 0720614.7

(51) Int. Cl. A01K 85/01; A01K 85/00; A01K 85/02

(52) U.S. Cl. 43/17.6; 43/26.2; 43/42.06; 43/42.44; 43/42

(57) ABSTRACT

A fishing lure (10) engages the senses of predatory fish, ie smell by the emission of fish oil from a compartment (74, FIG. 7), movement of the tail portion (18, FIG. 2), the colour of LED eyes (92, FIG. 3) and changeable rubber casings (16, 18, FIG. 2). Hooks (30, 32, 34, FIG. 3) provided on a body (12, 14, FIG. 2) of the lure (10) are biased towards the lure. The hooks (30, 32, 34) can be latched in a primed position, such that disturbance of the latch releases the hook, which is drawn rapidly towards the body of the lure (10).

The present invention relates to a fishing lure and particularly to a fishing lure for attracting and hooking predatory fish such as pike, zander and chub.

Both live-bait and dead-bait can be difficult to acquire and can only legally be used by fisherman, in the UK at least, during certain times in the fishing season. They are popular with anglers because they usually attract larger ‘specimen’ fish. Fishing such baits does have the advantage of removing the risk of snagging and losing expensive conventional lure, which have to be pulled through the water to simulate movement. However, there are drawbacks which can affect the successful hook up rate when using live-bait or dead-bait. This can be due to either a miss-timed strike, or the bait being mouthed and then spat out before the angler can strike due to the fish feeling the hook.

It is an object of the invention to provide a fishing lure which more closely simulates the characteristics of natural live-bait than existing conventional lure and which reduces or substantially obviates the above mentioned problems.

According to a first aspect of the present invention there is provided a fishing lure comprising a body portion and a tail portion, the tail portion being movable relative to the body portion, drive means for driving the tail portion relative to the body portion and control means for controlling operation of the drive means, the control means being adapted to operate the drive means intermittently for causing erratic movement of the tail portion relative to the body portion.

This movement of the tail portion is advantageous because it mimics the movement of a real fish.

The erratic or irregular movement is extremely effective, because it mimics a dying or injured fish, which is easy prey for a predator.

The drive means may include an electric motor and a gear box.

The tail portion may be driven through an eccentric cam.

The control means may include a programmed printed circuit board.

A battery may be provided in a waterproof compartment.

The lure may include at least one hook, the hook being spring mounted and biased towards the body portion of the lure.

This is advantageous, because if a predatory fish mouths the hook, the hook moves off the latch and is drawn rapidly towards the body of the lure, thus hooking the fish. In other words, the inward movement of the hook is triggered.

A plurality of hooks may be spring mounted and biased towards the body portion of the lure.

Latch means may be provided for retaining the or each hook in a primed or set position with tension in the spring.

A compartment may be provided for receiving a scented liquid.

One or more apertures may be provided in the compartment to allow egress of the scented liquid from the compartment, for example, into surrounding water.

The liquid is preferably fish oil, such as pilchard oil.

The compartment may be located in the tail portion, movement of the tail portion causing egress of scented liquid.

A pair of visible LEDs may be provided on either side of the lure, which resemble fish eyes. This makes the lure more realistic, especially at night. The emitted light can cause reflections, particularly in shallow water.

According to a second aspect of the present invention there is provided a fishing lure comprising a body portion, at least one cavity disposed within the body portion and a hook biased into the cavity by a spring.

A latch means may be provided for retaining the or each hook in a primed position with tension in the spring.

According to a third aspect of the present invention there is provided a fishing lure comprising a compartment for receiving a scented liquid and one or more apertures in the compartment for allowing egress of the scented liquid from the compartment.

The fishing lure may further comprise a body portion and a tail portion, the tail portion being movable relative to the body portion, and the compartment being disposed in the tail portion.

For a better understanding of the present invention, and to show more clearly how it may be carried into effect, reference will now be made, by way of example, to the accompanying drawings, in which:

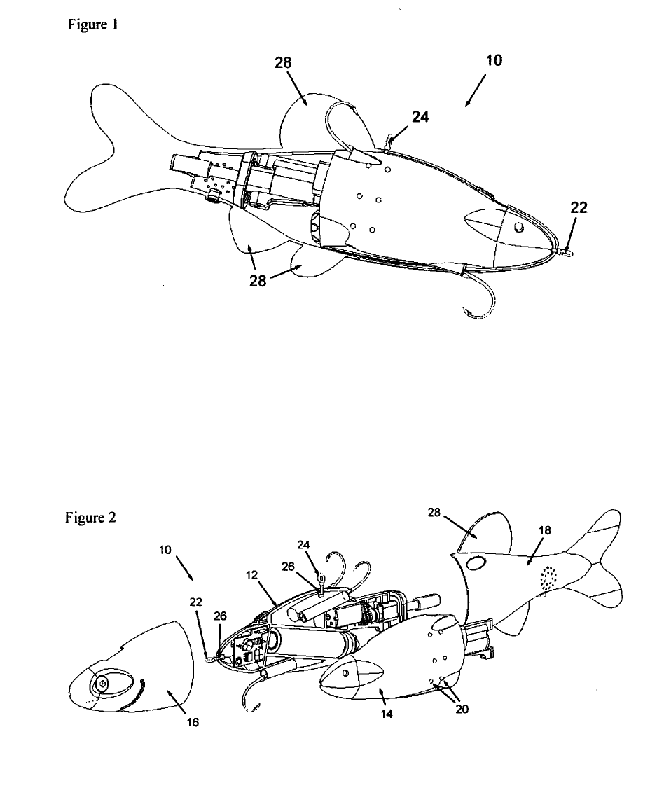

FIG. 1 shows a perspective view of a fishing lure, with part of the outer casing shown as transparent to reveal some of the internal components;

FIG. 2 shows an exploded perspective view of the fishing lure of FIG. 1;

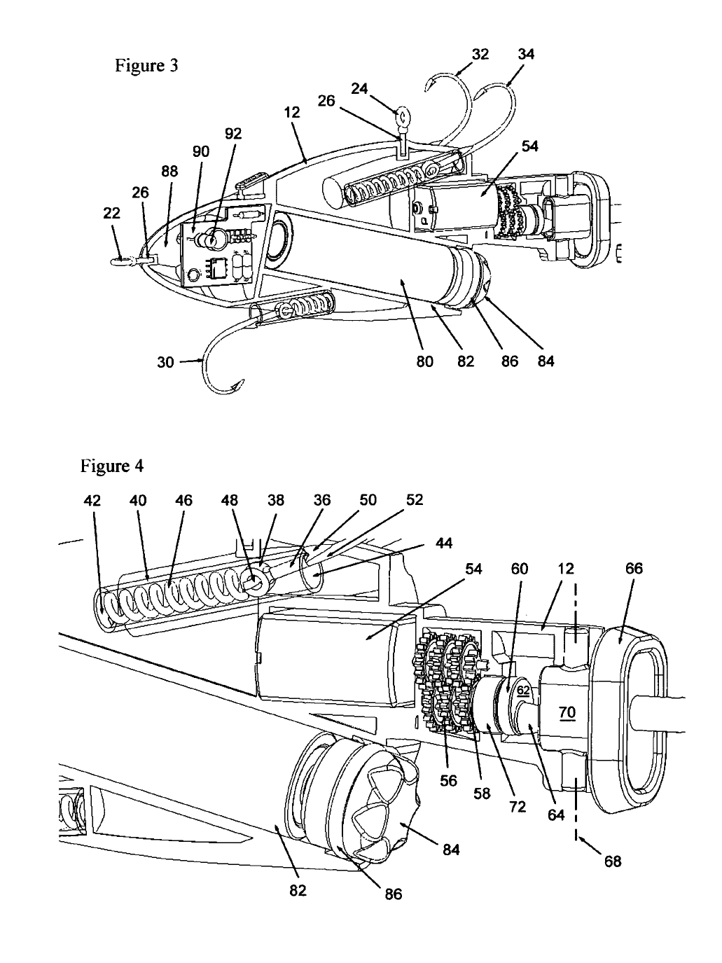

FIG. 3 shows a perspective side view of the internal components of the fishing lure of FIG. 1 mounted in one half of the housing;

FIG. 4 shows an enlarged view of some of the internal components of the fishing lure of FIG. 1 mounted in one half of the housing;

FIG. 5 shows a perspective view of the front of the assembled lure of FIG. 1;

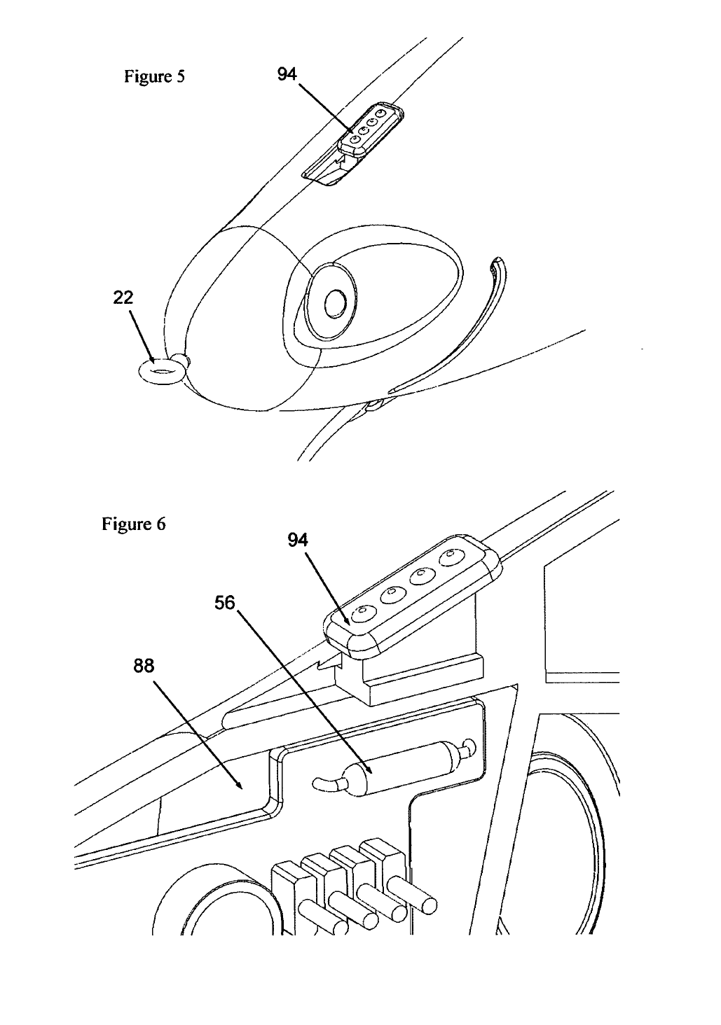

FIG. 6 shows a perspective side view of the internal components at the front of the fishing lure of FIG. 1 mounted in one half of the housing; and

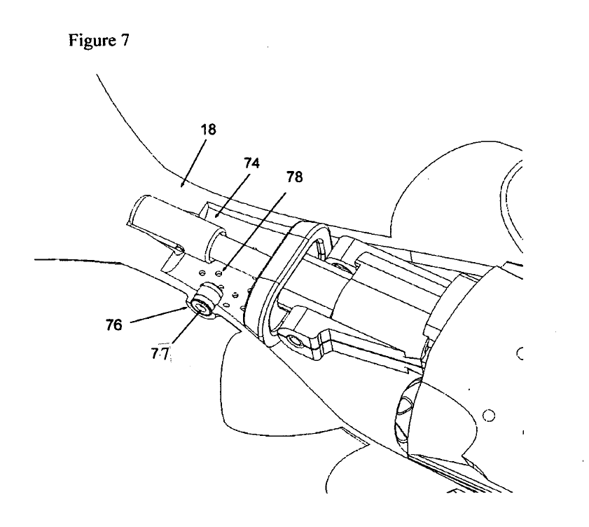

FIG. 7 shows a perspective view of the tail end of the lure of FIG. 1, with the rear outer casing shown only in outline to reveal the internal components.

Referring firstly to FIGS. 1 and 2, a fishing lure is indicated generally at 10. The fishing lure 10 includes a housing formed from first and second parts 12,14, in which internal components of the fishing lure 10 are received. The first and second parts 12, 14 of the housing are made from a suitable plastics, preferably transparent to reveal the components within, and the parts 12,14 are glued together with a waterproof adhesive. Any cavities inside the housing are filled with a suitable waterproof material, such as a clear acrylic resin. This ensures that the internal components are protected against water penetration and possible damage to the housing. Front and rear outer casings 16,18 fit onto respective front and rear ends of the assembled housing parts 12,14 and are held in place with resilient engagement onto semi-spherical raised elements 20 formed on the outside of the housing parts 12, 14. The front and rear outer casings 16,18 are made from silicone rubber or other suitably pliable material.

The assembled lure 10 is intended to look like a fish and is intended to mimic the movement of a fish, particularly a distressed or dying fish. It is also intended to give off a fish-like scent to attract predatory fish. The rear outer casing 18 is shaped as a fish tail with fins 28 and the front outer casing 16 is shaped as the head of a fish. Pairs of casings 16,18 can be provided in different colours and can be shaped to mimic different types of fish, as desired. These pairs of casings are easily and quickly changed by hand. Connection loops or eyes 22,24 for attachment to a fishing line are mounted at the front and upper sides respectively of the fishing lure. The loops 22,24 are each mounted on a stem 26, which is received in a respective recess formed in the housing.

Referring now to FIG. 3, three hooks 30,32,34 are mounted to the lure 10 for hooking a predatory fish. One of the hooks 30 is mounted to the underside of the lure 10 and the other two hooks 32,34 are mounted to the upper side or back of the lure. The upper hooks 32,34 are mounted one in each part of the housing 12,14 and they are angled away from one another for maximum hooking effect.

Referring also to FIG. 4, each hook 30,32,34 extends from a substantially straight shaft 36, which terminates in a loop 38. A circular stainless steel tube 40 has a closed end 42 and an open end 44. A coil spring 46 is received entirely within the tube 40 and one end of the spring 46 is fixed to the closed end 42. The other end of the spring is free to move and terminates in a hook 48, which is received in the loop 38 of a respective hook 30, 32, 34. A detent or locking member 50 is attached to the open end of the tube 40 and extends radially into the mouth of the tube. A notch or circumferential recess 52 is provided about the shaft 36 of each hook 30, 32, 34, which is adapted to receive the end of the detent. Each stainless steel tube 40 is received and retained in a tubular aperture in the housing.

The springs 46 bias the hooks into the ends of the tubes 40. In order to prime or set the hooks for fishing, each hook is pulled out of its respective tube 40 against the bias of the spring. The hook is retained in the primed position by the detent 50, which engages in the circumferential recess 52. If a fish makes a predatory strike against one of the hooks 30, 32, 34, the detent 50 is dislodged from the recess 52 and the hook is drawn rapidly into the tube. This action greatly enhances the chance of the hook engaging in the mouth of the fish.

In order to mimic the movement of a fish, the rear outer casing 18 is movable. An electric motor 54 is received in the housing parts 12,14, with the shaft of the motor extending towards the rear of the housing. The motor 54 drives a gear box 56 with an output shaft 58, which drives an eccentric cam 60. The eccentric cam 60 comprises a circular disc 62, driven about its central axis, with a tapered pin 64 extending away from the surface of the disc 62 at a point adjacent its periphery. A tail driving member 66 is mounted about an axis 68, indicated in dotted outline. The member 66 includes a substantially elongate hollow central portion 70, with an open end set to one side of the pivotal axis 68 and a drive member extending to the other side of the pivotal axis, aligned with the elongate hollow central portion 70. The tapered pin 64 extends into the elongate hollow central portion 70.

When the motor 54 drives the gear box, the output shaft 58 rotates the eccentric cam 60. The tapered pin 64 moves in a circular motion, and moves up and down (as viewed) within the substantially elongate hollow central portion 70. The portion 70 is not a tight fit on the pin 64, but is a clearance fit such that the pin can move freely whilst acting against the inner wall of the hollow portion 70 to push it from side to side (as viewed). For every rotation of the cam, the portion 70 moves to one side and back again, as does the tail driving member 66. The movement of the portion 70 about the pivot is small, but is amplified into the tail by the length of the member 66. A lip seal or waterproof bearing 72 is provided on the output shaft of the gear box 56 to seal the shaft against the housing parts 12,14.

With reference now to FIG. 7, the rear outer casing 18 of the lure, ie the tail of the fish is provided with an internal compartment 74. An inlet 76 to the compartment extends from the underside of the lure 10 (as viewed), in which is disposed a valve 77. A plurality of small apertures, indicated generally at 78, are provided in the side of the compartment 74 and through the wall of the casing 18. In use, the compartment can be filled with fish oil, for example, pilchard oil using a syringe. The valve 77 is a ball valve, having an external female thread, which can be connected to a corresponding male thread provided on the syringe. This fish oil slowly seeps through the apertures 78 and disperses around the lure. The action of the rear casing 18 being moved from side to side relative to the rest of the lure 10 tends to force the oil out through the apertures due to the difference in water pressure across the sides of the casing 18 as it moves.

A battery compartment 80, best seen in FIG. 3, is provided within the housing and houses a battery 82 for powering the lure. The battery may be rechargeable. The battery compartment has one open end, which is sealed with an external cap 84 having an O-ring seal 86. The battery 82 can easily be changed by removal of cap 84, thus allowing access to the compartment 80.

A further compartment 88 in the front of the housing contains a printed circuit board (PCB) 90, which controls the motor 54. A pair of LEDs 92 mounted on either side the PCB 90 illuminate to give the effect of fish eyes. The housing parts 12,14 have respective apertures through which the LEDs extend. The LEDs are sealed to the apertures by the clear acrylic resin. The front outer casing 16 is also provided with apertures so that the light emitted from the LEDs is visible.

Referring to FIGS. 5 and 6, an on/off switch 94 for the lure 10 is provided as a slider set into the upper side of the housing. The switch includes a magnet which operates a reed switch 96 mounted on the PCB underneath and proximate to the switch. This means that the PCB compartment 88 can be fully sealed.

To summarize, the lure 10 is a revolutionary new high tech fishing lure, which is capable of attracting and hooking predatory fish without the need to physically pull the lure through the water. This is advantageous because this is how most lures are snagged and lost. The appearance of the lure can be easily altered by changing the different colour and fish shaped rubber outer casings 16, 18, which can be produced inexpensively. The inner body formed from the first and second parts 12,14 of the lure is watertight and pressure resistant, in part due to the encasing of the electronics and motor in a clear acrylic resin.

In use, the lure engages all of the senses of as predatory fish, ie smell by the emission of fish oil, movement of the tail, and the colour of the LED eyes and changeable rubber casings. The lure is used in the same way as a dead or live bait with the added advantage that it is legal (in the UK) and available all year round.

To enhance the effectiveness of the lure 10, the PCB is programmed to activate the motor and hence the tail casing erratically, so that the movement mimics a dying fish. In other words, the motor does not rotate constantly at a fixed speed, which would make the tail move in simple harmonic motion. Rather, the motor is stopped and started from time to time, and is operated at different speeds. This provokes a quicker attack and the prey is immediately hooked by the spring loaded hooks. The hooks improve the catch rate of an angler by preventing the fish spitting the bait or from not hooking the fish due to a late strike. Furthermore, the lure may also be provided with a vibrator (not shown) for creating an enhanced disturbance in the water. The lure 10 does not need to be pulled though the water lure and can be connected to a trace from either the top or front to change its presentation in the water. The fish oil compartment emits fish oil, which attracts fish both in a large area of stagnant water and/or down stream in moving water.

It is understood that variations may be made in the foregoing without departing from the scope of the invention. For example, the elements and teachings of the various illustrative embodiments may be combined in whole or in part in some or all of the illustrative embodiments. In addition, one or more of the elements and teachings of the various illustrative embodiments may be omitted, at least in part, and/or combined, at least in part, with one or more of the other elements and teachings of the various illustrative embodiments.

Although illustrative embodiments of the invention have been shown and described, a wide range of modification, changes and substitution is contemplated in the foregoing disclosure. In some instances, some features of the invention may be employed without a corresponding use of the other features. Accordingly, it is appropriate that the appended claims be construed broadly and in a manner consistent with the scope of the invention.

1. A fishing lure comprising a body portion and a tail portion the tail portion being movable relative to the body portion, drive means for driving the tail portion relative to the body portion and control means for controlling operation of the drive means, the control means being adapted to operate the drive means intermittently for causing erratic movement of the tail portion relative to the body portion, the drive means including a pin eccentrically mounted to a circular disc, and the pin directly drives the tail portion on rotation of the disc by engaging the tail portion and pushing it from side to side relative to the body portion.

2. The fishing lure of claim 1, in which the drive means includes an electric motor.

3. The fishing lure of claim 1, in which the drive means further includes a gear box.

4. (canceled)

5. The fishing lure of claim 1 in which the control means includes a programmed printed circuit board.

6. The fishing lure of claim 1 further comprising a battery for powering the drive means is disposed in a waterproof battery compartment.

7. The fishing lure of claim 1, in which the lure includes a first hook mounted to the underside of the lure and a second hook mounted to the back of the lure, each hook being spring mounted and biased towards the body portion of the lure.

8. (canceled)

9. The fishing lure of claim 7, in which latch means is provided for retaining a hook in a primed position with tension in the spring.

10. The fishing lure of claim 1, further comprising a compartment is provided for receiving a scented liquid.

11. The fishing lure of claim 10, in which one or more apertures is provided in the compartment to allow egress of the scented liquid from the compartment.

12. The fishing lure of claim 10, in which the compartment is disposed in the tail portion, and movement of the tail portion by the drive means facilitates egress of the scented liquid from the compartment.

13. The fishing lure of claim 10 further comprising a valve, through which the compartment can be filled with scented liquid.

14. The fishing lure of claim 1 further comprising at least one visible LED on either side of the lure.

15. (canceled)

16. (canceled)

17. (canceled)

18. (canceled)

19. (canceled)

20. The fishing lure of claim 7 further comprising a tube for each biased hook, each tube being mounted at an angle relative to a central axis of the lure.

21. The fishing lure of claim 1 further comprising a changeable rubber casing disposed over the body portion.
